(19) United States
(12) Patent Application Publication
(10) Pub. No.: US 2008/0084932 A1
(43) Pub. Date: Apr. 10, 2008

(54) Controlling loop filtering for interlaced video frames

(75) Inventors: Ce Wang, Bellevue, WA (US); Gary J. Sullivan, Redmond, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/544,382

(22) Filed: Oct. 6, 2006

(51) Int. Cl. H04N 11/04; H04B 1/66

(52) U.S. Cl. 375/240.24; 375/240.29

(57) ABSTRACT

Techniques and tools are described for parameterization, signaling and use of in-loop filtering control information for interlaced video frames in video acceleration. For example, for a macroblock of an interlaced video frame, a decoder parameterizes in-loop filtering decisions as filter control information for video acceleration. The control information indicates filtering control decisions for external edges and internal edges of luma blocks and chroma blocks of the macroblock. The decoder makes the control information available to a video accelerator. The video accelerator retrieves the in-loop filtering control information. For a macroblock of an interlaced video frame, the video accelerator then performs in-loop filtering based at least in part on the control information.

### BACKGROUND

Companies and consumers increasingly depend on computers to process, distribute, and play back high quality video content. Engineers use compression (also called source coding or source encoding) to reduce the bit rate of digital video. Compression decreases the cost of storing and transmitting video information by converting the information into a lower bit rate form. Decompression (also called decoding) reconstructs a version of the original information from the compressed form. A “codec” is an encoder/decoder system.

Compression can be lossless, in which the quality of the video does not suffer, but decreases in bit rate are limited by the inherent amount of variability (sometimes called source entropy) of the input video data. Or, compression can be lossy, in which the quality of the video suffers, and the lost quality cannot be completely recovered, but achievable decreases in bit rate are more dramatic. Lossy compression is often used in conjunction with lossless compression—lossy compression establishes an approximation of information, and the lossless compression is applied to represent the approximation.

In general, video compression techniques include “intra-picture” compression and “inter-picture” compression. Intra-picture compression techniques compress a picture with reference to information within the picture, and inter-picture compression techniques compress a picture with reference to a preceding and/or following picture (often called a reference or anchor picture) or pictures.

For intra-picture compression, for example, an encoder splits a picture into 8×8 blocks of samples, where a sample is a number that represents the intensity of brightness or the intensity of a color component for a small, elementary region of the picture, and the samples of the picture are organized as arrays or planes. The encoder applies a frequency transform to individual blocks. The frequency transform converts an 8×8 block of samples into an 8×8 block of transform coefficients. The encoder quantizes the transform coefficients, which may result in lossy compression. For lossless compression, the encoder entropy codes the quantized transform coefficients.

Inter-picture compression techniques often use motion estimation and motion compensation to reduce bit rate by exploiting temporal redundancy in a video sequence. Motion estimation is a process for estimating motion between pictures. For example, for an 8×8 block of samples or other unit of the current picture, the encoder attempts to find a match of the same size in a search area in another picture, the reference picture. Within the search area, the encoder compares the current unit to various candidates in order to find a candidate that is a good match. When the encoder finds an exact or “close enough” match, the encoder parameterizes the change in position between the current and candidate units as motion data (such as a motion vector (“MV”)). In general, motion compensation is a process of reconstructing pictures from reference picture(s) using motion data.

The example encoder also computes the sample-by-sample difference between the original current unit and its motion-compensated prediction to determine a residual (also called a prediction residual or error signal). The encoder then applies a frequency transform to the residual, resulting in transform coefficients. The encoder quantizes the transform coefficients and entropy codes the quantized transform coefficients.

If an intra-compressed picture or motion-predicted picture is used as a reference picture for subsequent motion compensation, the encoder reconstructs the picture. A decoder also reconstructs pictures during decoding, and it uses some of the reconstructed pictures as reference pictures in motion compensation. For example, for an 8×8 block of samples of an intra-compressed picture, an example decoder reconstructs a block of quantized transform coefficients. The example decoder and encoder perform inverse quantization and an inverse frequency transform to produce a reconstructed version of the original 8×8 block of samples.

As another example, the example decoder or encoder reconstructs an 8×8 block from a prediction residual for the block. The decoder decodes entropy-coded information representing the prediction residual. The decoder/encoder inverse quantizes and inverse frequency transforms the data, resulting in a reconstructed residual. In a separate motion compensation path, the decoder/encoder computes an 8×8 predicted block using motion vector information for displacement from a reference picture. The decoder/encoder then combines the predicted block with the reconstructed residual to form the reconstructed 8×8 block.

### I. Organization of Video Frames.

In some cases, the example encoder and example decoder process video frames organized as shown in FIGS. 1, 2A, 2B and 2C. For progressive video, lines of a video frame contain samples starting from one time instant and continuing through successive lines to the bottom of the frame. An interlaced video frame consists of two scans—one for the even lines of the frame (the top field) and the other for the odd lines of the frame (the bottom field).

A progressive video frame can be divided into 16×16 macroblocks such as the macroblock (100) shown in FIG. 1. The macroblock (100) includes four 8×8 blocks (Y0 through Y3) of luma (or brightness) samples and two 8×8 blocks (Cb, Cr) of chroma (or color component) samples, which are co-located with the four luma blocks but half resolution horizontally and vertically.

FIG. 2A shows part of an interlaced video frame (200), including the alternating lines of the top field and bottom field at the top left part of the interlaced video frame (200). The two fields may represent two different time periods or they may be from the same time period. When the two fields of a frame represent different time periods, this can create jagged tooth-like features in regions of the frame where motion is present.

Therefore, interlaced video frames can be rearranged according to a field structure, with the odd lines grouped together in one field, and the even lines grouped together in another field. This arrangement, known as field coding, is useful in high-motion pictures. FIG. 2C shows the interlaced video frame (200) of FIG. 2A organized for encoding/decoding as fields (260). Each of the two fields of the interlaced video frame (200) is partitioned into macroblocks. The top field is partitioned into macroblocks such as the macroblock (261), and the bottom field is partitioned into macroblocks such as the macroblock (262). (The macroblocks can use a format as shown in FIG. 1, and the organization and placement of luma blocks and chroma blocks within the macroblocks are not shown.) In the luma plane, the macroblock (261) includes 16 lines from the top field and the macroblock (262) includes 16 lines from the bottom field, and each line is 16 samples long.

On the other hand, in stationary regions, image detail in the interlaced video frame may be more efficiently preserved without rearrangement into separate fields. Accordingly, frame coding is often used in stationary or low-motion interlaced video frames. FIG. 2B shows the interlaced video frame (200) of FIG. 2A organized for encoding/decoding as a frame (230). The interlaced video frame (200) has been partitioned into macroblocks such as the macroblocks (231) and (232), which use a format as shown in FIG. 1. In the luma plane, each macroblock (231, 232) includes 8 lines from the top field alternating with 8 lines from the bottom field for 16 lines total, and each line is 16 samples long. (The actual organization and placement of luma blocks and chroma blocks within the macroblocks (231, 232) are not shown, and in fact may vary for different encoding decisions.) Within a given macroblock, the top-field information and bottom-field information may be coded jointly or separately at any of various phases—the macroblock itself may be field coded or frame coded.

### II. Loop Filtering in Video Compression and Decompression.

Quantization and other lossy processing can result in visible lines at boundaries between blocks. This might occur, for example, if adjacent blocks in a smoothly changing region of a picture (such as a sky area) are quantized to different average levels. Blocking artifacts can be especially troublesome in reference pictures that are used for motion estimation and compensation. To reduce blocking artifacts, the example encoder and decoder use “deblock” filtering to smooth boundary discontinuities between blocks in reference pictures. The filtering is “in-loop” in that it occurs inside a motion-compensation loop—the encoder and decoder perform it on reference pictures used for subsequent encoding/decoding. Deblock filtering improves the quality of motion estimation/compensation, resulting in better motion-compensated prediction and lower bitrate for prediction residuals.

Various video standards and products incorporate in-loop deblock filtering. The details of the filtering vary depending on the standard or product. Even within a standard or product, the rules of applying deblock filtering can vary depending on factors such as:
(a) Content. In many cases, deblock filtering is content-adaptive in that the encoder/decoder reduces or skips deblock filtering if, for example, the boundary between two blocks is already very smooth, or the two blocks contain complex detail on both sides of the boundary, or the boundary aligns with the edge of an object in the picture.
(b) Block size. In some cases, an encoder and decoder use transform block sizes that vary from block to block.
(c) Coded/not coded status. In some cases, the encoder and decoder selectively perform filtering depending on whether blocks have been coded or not coded (reconstructed without new encoded information).
(d) Progressive/interlaced field/interlaced frame mode. In some cases, deblock filtering is performed differently for progressive video content, interlaced video content encoded as fields, and interlaced video content encoded as frames.

FIG. 3 shows possible block/subblock boundaries when an encoder and decoder perform in-loop filtering in a motion-compensated progressive video frame, and the encoder and decoder use transforms of varying size (8×8, 8×4, 4×8 or 4×4) for “inter” blocks. (“Intra” blocks have a transform size of 8×8 .) A shaded block/subblock indicates the block/subblock is coded. Thick lines represent the boundaries that are adaptively filtered, and thin lines represent the boundaries that are not filtered. Depending on the status of the neighboring block, the boundary between a current block and neighboring block may or may not be adaptively filtered. The boundaries between coded subblocks within an 8×8 block are always adaptively filtered. The boundary between a block/subblock and a neighboring block/subblock is filtered unless both are inter, have the same motion vector, and are not coded. FIG. 3 illustrates only horizontal macroblock neighbors, but the example encoder and decoder apply similar rules to vertical neighbors.

When an encoder and decoder perform in-loop filtering across block boundaries of blocks of a reference field, a given block includes either lines of a top field or lines of a bottom field. When blocks are divided into subblocks, the possible block boundaries are similar to those shown in FIG. 3.

In the example encoder and decoder, deblock filtering for interlaced frames is more complex. Interlaced frames are split into 8×8 blocks, and inter blocks may be further split into 8×4, 4×8 or 4×4 transform subblocks. Prior to the transform coding, the encoder/decoder can permute a macroblock for field coding, organizing top field lines and bottom field lines into separate blocks for coding. Filtering lines of different fields together can introduce blurring and distortion when the fields are scanned at different times. Thus, the encoder and decoder filter top field lines separately from bottom field lines during in-loop deblock filtering.

For example, for a horizontal block boundary between a current block and a neighboring block above it, samples of the two top field lines on opposing sides of the boundary are filtered across the boundary using samples of top field lines only, and samples of the two bottom field lines on opposing sides of the boundary are filtered using samples of bottom field lines only. For a vertical block boundary between the current block and a neighboring block to the left, samples of the top field lines on opposing sides of the boundary are filtered across the boundary, and samples of the bottom field lines on opposing sides of the boundary are separately filtered across the boundary. The rules for applying deblock filtering to edges of blocks/subblocks in a reference interlaced video frame typically account for content, transform size, coded/not coded status, and whether a given block is field-coded or frame-coded. Separately for top field lines and bottom field lines of a block of an interlaced video frame, deblock filtering might or might not be applied to left block edges, top block edges, horizontal subblock edges within the block, and vertical subblock edges within the block.

Other encoders and decoders apply different rules for in-loop deblock filtering. For example, different standards specify different filters for in-loop deblock filtering and specify different rules for adaptively applying the filters. As another example, different standards have different available transform sizes and different ways of incorporating field-coding/frame-coding decisions for interlaced video frames.

### III. Acceleration of Video Decoding and Encoding.

While some video decoding and encoding operations are relatively simple, others are computationally complex. For example, inverse frequency transforms, fractional sample interpolation operations for motion compensation, in-loop deblock filtering, post-processing filtering, color conversion, and video re-sizing can require extensive computation. This computational complexity can be problematic in various scenarios, such as decoding of high-quality, high-bit rate video (e.g., compressed high-definition video).

Some decoders use video acceleration to offload selected computationally intensive operations to a graphics processor. For example, in some configurations, a computer system includes a primary central processing unit (“CPU”) as well as a graphics processing unit (“GPU”) or other hardware specially adapted for graphics processing. A decoder uses the primary CPU as a host to control overall decoding and uses the GPU to perform simple operations that collectively require extensive computation, accomplishing video acceleration.

FIG. 4 shows a simplified software architecture (400) for video acceleration during video decoding. A video decoder (410) controls overall decoding and performs some decoding operations using a host CPU. The decoder (410) signals control information (e.g., picture parameters, macroblock parameters) and other information to a device driver (430) for a video accelerator (e.g., with GPU) across an acceleration interface (420).

The acceleration interface (420) is exposed to the decoder (410) as an application programming interface (“API”). The device driver (430) associated with the video accelerator is exposed through a device driver interface (“DDI”). In an example interaction, the decoder (410) fills a buffer with instructions and information then calls a method of an interface to alert the device driver (430) through the operating system. The buffered instructions and information, opaque to the operating system, are passed to the device driver (430) by reference, and video information is transferred to GPU memory if appropriate. While a particular implementation of the API and DDI may be tailored to a particular operating system or platform, in some cases, the API and/or DDI can be implemented for multiple different operating systems or platforms.

In some cases, the data structures and protocol used to parameterize acceleration information are conceptually separate from the mechanisms used to convey the information. In order to impose consistency in the format, organization and timing of the information passed between the decoder (410) and device driver (430), an interface specification can define a protocol for instructions and information for decoding according to a particular video decoding standard or product. The decoder (410) follows specified conventions when putting instructions and information in a buffer. The device driver (430) retrieves the buffered instructions and information according to the specified conventions and performs decoding appropriate to the standard or product. An interface specification for a specific standard or product is adapted to the particular bit stream syntax and semantics of the standard/product.

For example, a prior VC-1 decoder offloads in-loop deblock filtering operations to a video accelerator. To convey in-loop deblock filtering control information, the decoder uses a LOOPF_FLAG data structure for a macroblock of a progressive video frame.

typedef struct
{
BYTE chFlag [6];
} LOOPF_FLAG;

The six bytes in the LOOPF_FLAG structure have filter control information for the six 8×8 blocks of the macroblock of the progressive frame. For a given 8×8 block (510), the 8 bits of a LOOPF_FLAG byte (520) indicate whether or not particular 4-sample edges are filtered, as shown in FIG. 5. Bits 2 and 3 control in-loop filtering across the horizontal edges at the top of the 8×8 block (510), while bits 6 and 7 control in-loop filtering across the horizontal edges between 8×4 subblocks of the block (510). Bits 0 and 1 control in-loop filtering across the vertical edges at the left side of the 8×8 block (510), while bits 4 and 5 control in-loop filtering across the vertical edges between 4×8 subblocks of the block (510). If a bit has the value 1, the video accelerator performs adaptive in-loop filtering across the associated edge. If the bit has the value 0, the video accelerator skips adaptive in-loop filtering across the associated edge. Prior uses of LOOPF_FLAG are adapted for progressive video frames. They fail to address parameterization, signaling or use of in-loop filtering control information for interlaced video frames.

### SUMMARY

In summary, techniques and tools are described for parameterization, signaling and use of in-loop filtering control information for interlaced video frames in video acceleration. Control information protocols described herein are efficient and concise, simplifying implementation in encoders, decoders and video accelerators, and reducing the amount of control information that is signaled. In some cases, the protocols adopt syntax and data structures used for in-loop filter control information for progressive video frames, which further simplifies implementation. Different techniques and tools address different aspects of the protocol.

In one aspect, for a macroblock of an interlaced video frame, a tool such as an encoder or decoder parameterizes in-loop filtering decisions as filter control information for video acceleration. The control information indicates filtering control decisions for external edges and internal edges of luma blocks and chroma blocks of the macroblock. The tool then makes the control information available to a video accelerator, for example, by writing it to a buffer.

In another aspect, a tool such as a video accelerator retrieves in-loop filtering control information for video acceleration, for example, reading it from a buffer. For a macroblock of an interlaced video frame, the tool then performs in-loop filtering based at least in part on the control information.

In another aspect, a tool such as operating system software implementing an acceleration interface receives in-loop filtering control information for an interlaced video frame. The tool invokes a method of an interface of a video accelerator, thereby indicating availability of the control information to the video accelerator.

The various techniques and tools can be used in combination or independently. Additional features and advantages will be made more apparent from the following detailed description of different embodiments, which proceeds with reference to the accompanying figures.

### BRIEF DESCRIPTION OF THE DRAWINGS

FIG. 1 is a diagram of a macroblock format according to the prior art.

FIG. 2A is a diagram of part of an interlaced video frame, FIG. 2B is a diagram of the interlaced video frame organized for encoding/decoding as a frame, and FIG. 2C is a diagram of the interlaced video frame organized for encoding/decoding as fields, according to the prior art.

FIG. 3 is a diagram showing possible block/subblock boundaries between horizontally neighboring blocks in a progressive motion-compensated frame according to the prior art.

FIG. 4 is a block diagram illustrating a simplified architecture for video acceleration during video decoding according to the prior art.

FIG. 5 is a diagram illustrating signaling of in-loop deblock filtering control information for a block of a progressive video frame according to the prior art.

FIG. 6 is a block diagram illustrating a generalized example of a suitable computing environment in which several of the described embodiments may be implemented.

FIG. 7 is a block diagram of a generalized video decoder in conjunction with which several of the described embodiments may be implemented.

FIG. 8 is a diagram illustrating syntax and semantics of in-loop deblock filtering control information for a block of an interlaced video frame.

FIG. 9 is a flowchart showing a generalized technique for signaling in-loop filtering control information for a macroblock of an interlaced video frame, and

FIG. 10 is a flowchart showing additional timing details in some embodiments.

FIG. 11 is a flowchart showing a generalized technique for transferring in-loop filtering control information for interlaced video frames.

FIG. 12 is a flowchart showing a generalized technique for receiving and processing in-loop filtering control information for a macroblock of an interlaced video frame.

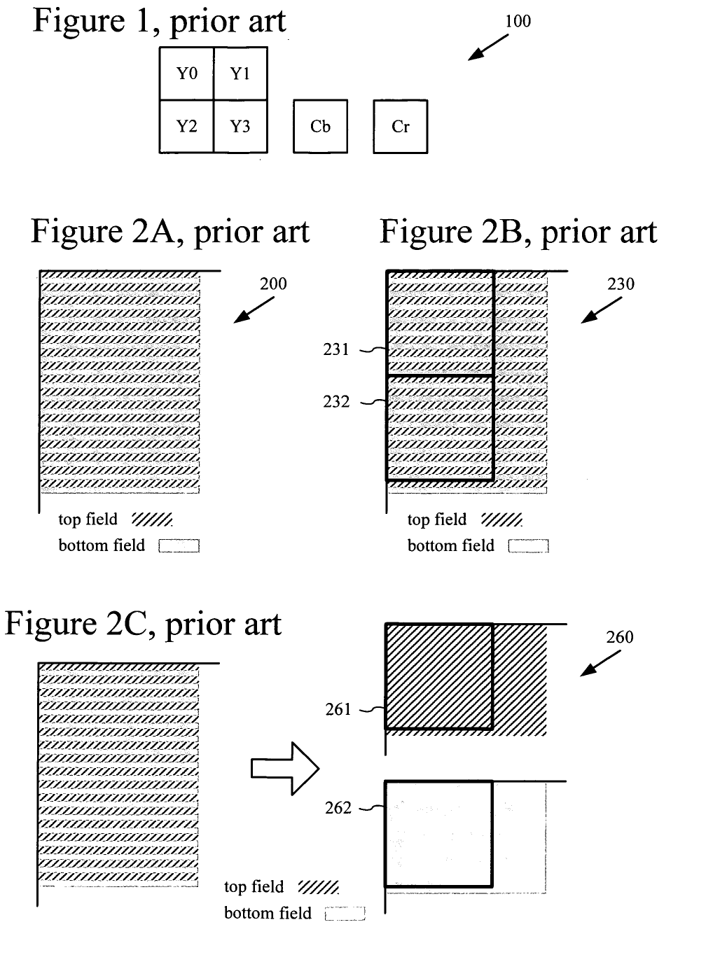

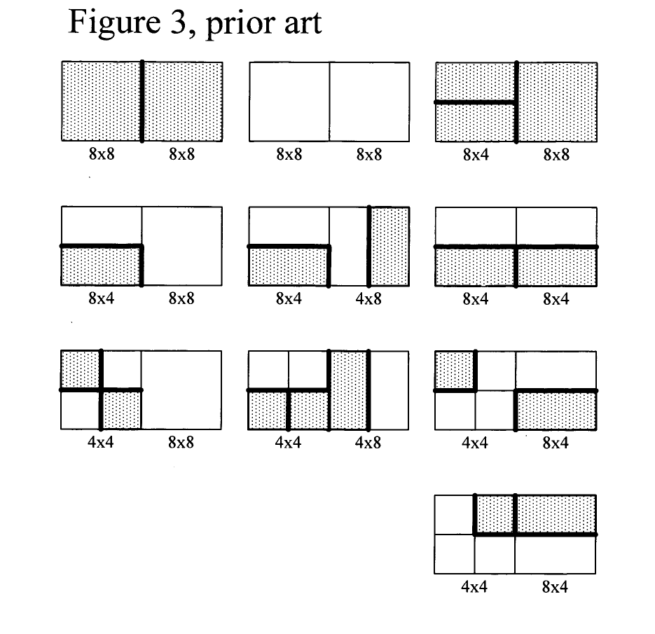

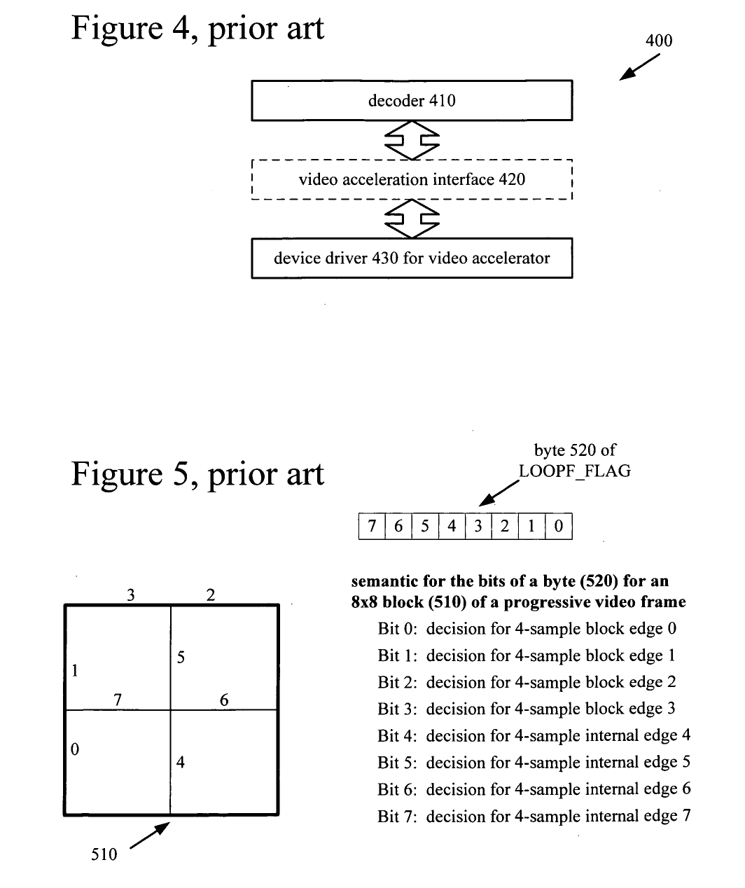

### DETAILED DESCRIPTION

Techniques and tools for video acceleration of in-loop filtering for interlaced video frames are described herein. Efficient, concise protocols for in-loop filter control information, for example, simplify implementation in encoders, decoders and video accelerators, and reduce the amount of control information that is signaled. In some cases, the protocols reuse the syntax and/or data structures from filter control information for progressive video frames, which further simplifies implementation.

Various alternatives to the implementations described herein are possible. For example, certain techniques described with reference to flowchart diagrams can be altered by changing the ordering of stages shown in the flowcharts, by repeating or omitting certain stages, etc., while achieving the same result. As another example, although some implementations are described with reference to specific macroblock formats, other formats also can be used. Different embodiments implement one or more of the described techniques and tools. Some of the techniques and tools described herein address one or more of the problems noted in the Background. Typically, a given technique/tool does not solve all such problems, however.

### I. Computing Environment.

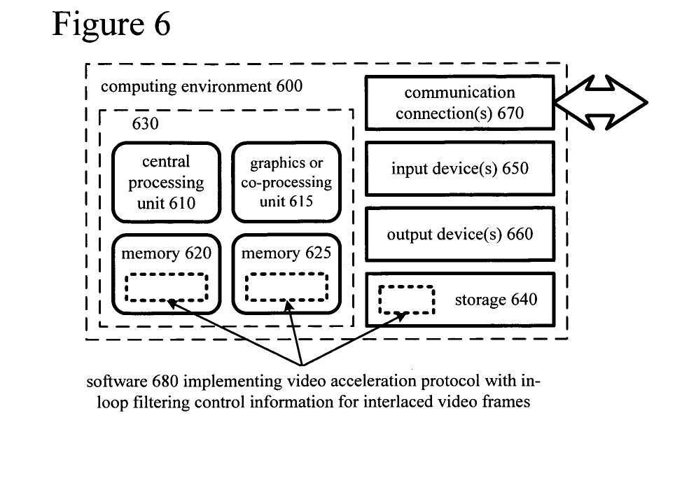

FIG. 6 illustrates a generalized example of a suitable computing environment (600) in which several of the described embodiments may be implemented. The computing environment (600) is not intended to suggest any limitation as to scope of use or functionality, as the techniques and tools may be implemented in diverse general-purpose or special-purpose computing environments.

With reference to FIG. 6, the computing environment (600) includes at least one CPU (610) and associated memory (620) as well as at least one GPU or other co-processing unit (615) and associated memory (625) used for video acceleration. In FIG. 6, this most basic configuration (630) is included within a dashed line. The processing unit (610) executes computer-executable instructions and may be a real or a virtual processor. In a multi-processing system, multiple processing units execute computer-executable instructions to increase processing power. A host encoder or decoder process offloads certain computationally intensive operations (e.g., fractional sample interpolation for motion compensation, in-loop deblock filtering) to the GPU (615). The memory (620, 625) may be volatile memory (e.g., registers, cache, RAM), non-volatile memory (e.g., ROM, EEPROM, flash memory, etc.), or some combination of the two. The memory (620, 625) stores software (680) for an encoder and/or decoder implementing a video acceleration protocol with in-loop filtering control information for interlaced video frames.

A computing environment may have additional features. For example, the computing environment (600) includes storage (640), one or more input devices (650), one or more output devices (660), and one or more communication connections (670). An interconnection mechanism (not shown) such as a bus, controller, or network interconnects the components of the computing environment (600). Typically, operating system software (not shown) provides an operating environment for other software executing in the computing environment (600), and coordinates activities of the components of the computing environment (600).

The storage (640) may be removable or non-removable, and includes magnetic disks, magnetic tapes or cassettes, CD-ROMs, DVDs, or any other medium which can be used to store information and which can be accessed within the computing environment (600). The storage (640) stores instructions for the software (680).

The input device(s) (650) may be a touch input device such as a keyboard, mouse, pen, or trackball, a voice input device, a scanning device, or another device that provides input to the computing environment (600). For audio or video encoding, the input device(s) (650) may be a sound card, video card, TV tuner card, or similar device that accepts audio or video input in analog or digital form, or a CD-ROM or CD-RW that reads audio or video samples into the computing environment (600). The output device(s) (660) may be a display, printer, speaker, CD-writer, or another device that provides output from the computing environment (600).

The communication connection(s) (670) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of computer-readable media. Computer-readable media are any available media that can be accessed within a computing environment. By way of example, and not limitation, with the computing environment (600), computer-readable media include memory (620), storage (640), communication media, and combinations of any of the above.

The techniques and tools can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “decide,” “make” and “get” to describe computer operations in a computing environment. These terms are high-level abstractions for operations performed by a computer, and should not be confused with acts performed by a human being. The actual computer operations corresponding to these terms vary depending on implementation.

### II. In-Loop Filtering in a Generalized Video Decoder.

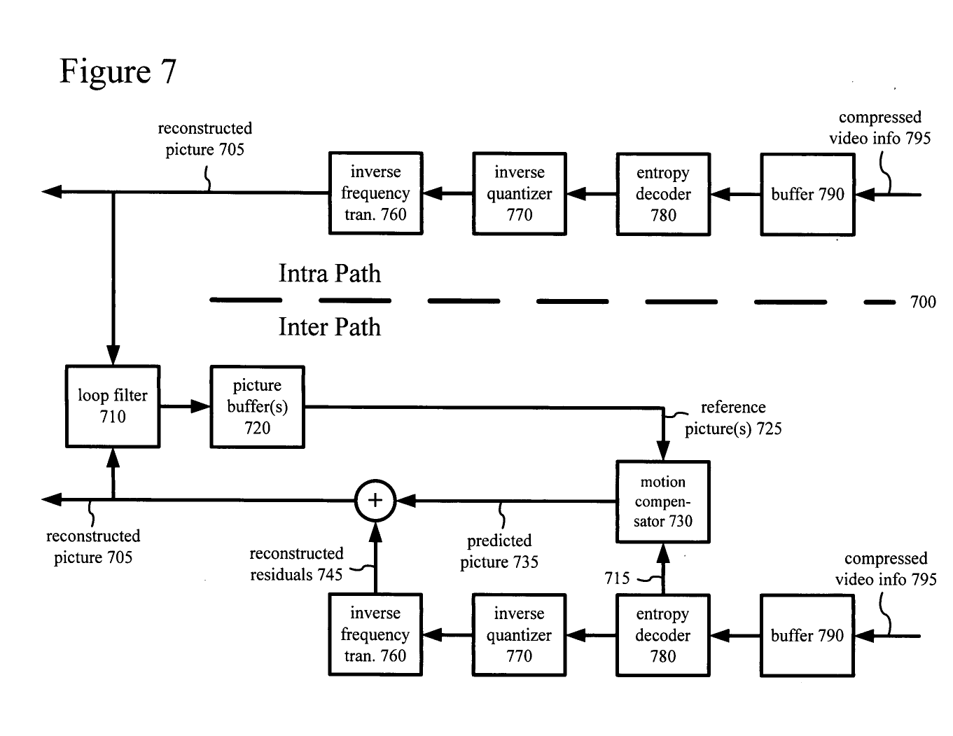

FIG. 7 is a block diagram of a generalized video decoder (700) in conjunction with which several described embodiments may be implemented. A corresponding video encoder (not shown) may also implement one or more of the described embodiments.

The relationships shown between modules within the decoder (700) indicate general flows of information in the decoder; other relationships are not shown for the sake of simplicity. In particular, while a decoder host performs some operations of modules of the decoder (700), a video accelerator performs other operations (such as inverse frequency transforms, fractional sample interpolation, motion compensation, in-loop deblocking filtering, color conversion, post-processing filtering and/or picture re-sizing). For example, the decoder (700) passes instructions Acceleration API/DDI,” version 1.01. Alternatively, the decoder (700) passes instructions and information to the video accelerator using another mechanism, such as one described in a later version of DXVA or another acceleration interface. In general, once the video accelerator reconstructs video information, it maintains some representation of the video information rather than passing information back. For example, after a video accelerator reconstructs an output picture, the accelerator stores it in a picture store, such as one in memory associated with a GPU, for use as a reference picture. The accelerator then performs in-loop deblock filtering and fractional sample interpolation on the picture in the picture store.

In some implementations, different video acceleration profiles result in different operations being offloaded to a video accelerator. For example, one profile may only offload out-of-loop, post-decoding operations, while another profile offloads in-loop filtering, fractional sample interpolation and motion compensation as well as the post-decoding operations. Still another profile can further offload frequency transform operations. In still other cases, different profiles each include operations not in any other profile.

Returning to FIG. 7, the decoder (700) processes video pictures, which may be video frames, video fields or combinations of frames and fields. The bitstream syntax and semantics at the picture and macroblock levels may depend on whether frames or fields are used. The decoder (700) is block-based and uses a 4:2:0 macroblock format for frames. For fields, the same or a different macroblock organization and format may be used. 8×8 blocks may be further sub-divided at different stages. Alternatively, the decoder (700) uses a different macroblock or block format, or performs operations on sets of samples of different size or configuration.

The decoder (700) receives information (795) for a compressed sequence of video pictures and produces output including a reconstructed picture (705) (e.g., progressive video frame, interlaced video frame, or field of an interlaced video frame). The decoder system (700) decompresses predicted pictures and key pictures. For the sake of presentation, FIG. 7 shows a path for key pictures through the decoder system (700) and a path for predicted pictures. Many of the components of the decoder system (700) are used for decompressing both key pictures and predicted pictures. The exact operations performed by those components can vary depending on the type of information being decompressed.

A demultiplexer (790) receives the information (795) for the compressed video sequence and makes the received information available to the entropy decoder (780). The entropy decoder (780) entropy decodes entropy-coded quantized data as well as entropy-coded side information, typically applying the inverse of entropy encoding performed in the encoder. A motion compensator (730) applies motion information (715) to one or more reference pictures (725) to form motion-compensated predictions (735) of subblocks, blocks and/or macroblocks of the picture (705) being reconstructed. One or more picture stores store previously reconstructed pictures for use as reference pictures.

The decoder (700) also reconstructs prediction residuals. An inverse quantizer (770) inverse quantizes entropy-decoded data. An inverse frequency transformer (760) converts the quantized, frequency domain data into spatial domain video information. For example, the inverse frequency transformer (760) applies an inverse block transform to subblocks and/or blocks of the frequency transform coefficients, producing sample data or prediction residual data for key pictures or predicted pictures, respectively. The inverse frequency transformer (760) may apply an 8×8, 8×4, 4×8, 4×4, or other size inverse frequency transform.

For a predicted picture, the decoder (700) combines reconstructed prediction residuals (745) with motion compensated predictions (735) to form the reconstructed picture (705). A motion compensation loop in the video decoder (700) includes an adaptive deblocking filter (723). The decoder (700) applies in-loop filtering (723) to the reconstructed picture to adaptively smooth discontinuities across block/subblock boundary rows and/or columns in the picture. The decoder stores the reconstructed picture in a picture buffer (720) for use as a possible reference picture. For example, the decoder (700) performs in-loop deblock filtering operations as described in U.S. Patent Application Publication No. US-2005-0084012-A1, entitled “IN-LOOP DEBLOCKING FOR INTERLACED VIDEO.” Alternatively, the decoder (700) performs in-loop deblock filtering operations using another mechanism.

Depending on implementation and the type of compression desired, modules of the decoder can be added, omitted, split into multiple modules, combined with other modules, and/or replaced with like modules. In alternative embodiments, encoders or decoders with different modules and/or other configurations of modules perform one or more of the described techniques. Specific embodiments of video decoders typically use a variation or supplemented version of the generalized decoder (700).

### III. Acceleration Control Information for In-Loop Filtering of Interlaced Video Content.

In-loop filtering operations for interlaced video content are typically different, and more complex, than in-loop filtering operations for progressive video content. In some implementations, aside from the use of variable transform sizes (such as 8×8, 8×4, 4×8 and 4×4), the macroblocks of an interlaced video frame can be organized as frames or fields for encoding (see FIGS. 2A to 2C), and macroblocks in progressive mode, interlaced field mode, and interlaced frame mode have different in-loop filtering operations. In particular, when an encoder or decoder uses video acceleration for in-loop filtering operations in interlaced frame mode, the protocol used to communicate control information in progressive mode is unsuitable. This section describes techniques and tools for communicating control information for video acceleration of in-loop filtering operations in interlaced modes.

In some embodiments, an encoder/decoder and video accelerator redefine an existing progressive mode protocol for interlaced frame modes. For example, the encoder/decoder and video accelerator use the LOOPF_FLAG structure and syntax described above for signaling purposes but redefine the semantic to suit in-loop filtering for interlaced video frames. The LOOPF_FLAG structure and syntax are thus universal for all frame modes of such a codec. Alternatively, the encoder/decoder and video accelerator use different data structures and syntax to signal in-loop filtering control information in progressive mode, interlaced field mode and/or interlaced frame mode.

A. Example In-loop Filtering Control Information for Interlaced Frames.

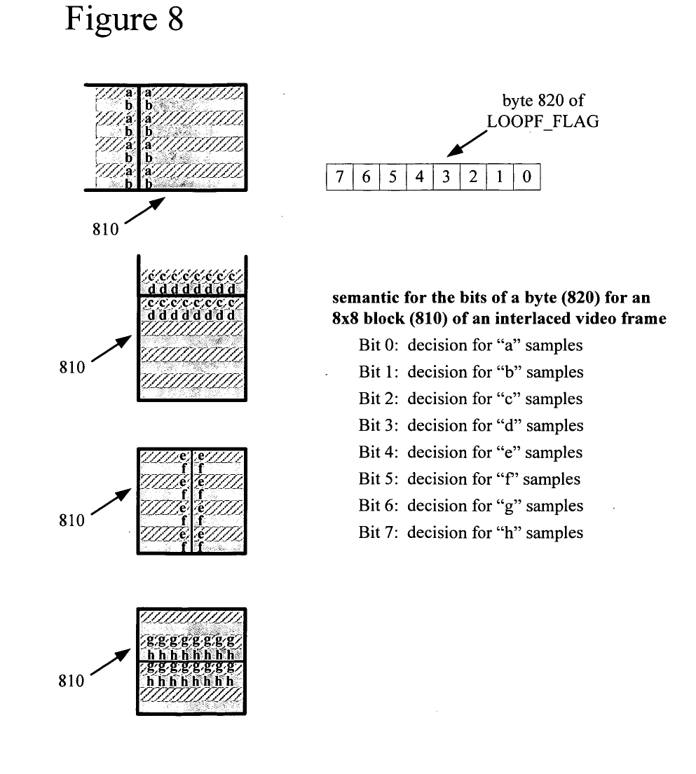

FIG. 8 illustrates signaling of in-loop deblock filtering control information in a LOOPF_FLAG structure for a macroblock of an interlaced video frame for video acceleration. As in the progressive mode case, the six bytes in the LOOPF_FLAG structure represent the loop filter control information for six 8×8 blocks of a macroblock. In one implementation, four bytes are sent for the four luma blocks, in raster scan order, followed by two bytes for the two chroma blocks. When present, each bit in a LOOPF_FLAG byte (820) controls the loop filtering of a piece of edge of the corresponding block (810) of a macroblock. In the LOOPF_FLAG byte (820), these bits are numbered from right to left such that bit 0 is the least significant bit and bit 7 is the most significant bit of the byte (820).

For a block of a progressive video frame, the significance of the bits of a LOOPF_FLAG byte is explained above with reference to FIG. 5. For an interlace field (top field or bottom field), the bits of a LOOPF_FLAG byte have much the same meaning as in progressive mode. In-loop filtering operations are applied on a frame basis in progressive mode, however, while they are applied on a field basis in interlaced field mode. For example, the top left luma block of a progressive mode macroblock includes rows 0 . . . 7 of samples and columns 0 . . . 7 of samples of the macroblock. Bit 1 indicates a vertical filtering decision for adjacent top rows 0 . . . 3 of the block, and bit 0 indicates a vertical filtering decision for adjacent bottom rows 4 . . . 7 of the block. On the other hand, the top left luma block of an interlaced field mode macroblock includes rows 0, 2, 4, 6, 8, 10, 12 and 14 of samples (top field samples) and columns 0 . . . 7 of samples. Bit 1 indicates a vertical filtering decision for “adjacent” top rows 0, 2, 4 and 6 of the block, and bit 0 indicates a vertical filtering decision for “adjacent” bottom rows 8, 10, 12 and 14 of the block. In-loop filtering operations are also applied on a field basis in interlace frame mode, but the bits of the LOOPF_FLAG byte (820) have different meanings than the progressive mode and interlaced field mode cases.

With reference to FIG. 8, bit 0 controls in-loop deblock filtering across the vertical edge at the left side of the 8×8 block (810) for samples of even-numbered rows (namely, rows 0, 2, 4, and 6, relative to the top of the 8×8 block (810)). In FIG. 8, the four samples “a” on each of the opposing sides of the edge—in columns −1 and 0 relative to the left side of the block (810)—are potentially affected by in-loop filtering when bit 0 indicates filtering is on. (If in-loop filtering is “on” for the edge, the filtering operations may consider other samples in the even-numbered rows of the block (810) and its neighbor to the left, and some of the samples “a” may in fact be unchanged by the filtering.)

Bit 1 controls in-loop deblock filtering across the vertical edge at the left side of the 8×8 block (810) for samples of odd-numbered rows (namely, rows 1, 3, 5 and 7). In FIG. 8, the four samples “b” on each of the opposing sides of the edge—in columns −1 and 0—are potentially affected by in-loop filtering when bit 1 indicates filtering is on.

Bit 2 controls in-loop deblock filtering across the horizontal edge at the top side of the 8×8 block (810) for samples of even-numbered rows. In FIG. 8, the eight samples “c” on each of the opposing sides of the edge—in rows −2 and 0 relative to the top side of the block (810)—are potentially affected by in-loop filtering when bit 2 indicates filtering is on.

Bit 3 controls in-loop deblock filtering across the horizontal edge at the top side of the 8×8 block (810) for samples of odd-numbered rows. In FIG. 8, the eight samples “d” on each of the opposing sides of the edge—in rows −1 and 1—are potentially affected by in-loop filtering when bit 3 indicates filtering is on.

Bit 4 controls in-loop deblock filtering across the vertical edge in the middle of the 8×8 block (810) for samples of even-numbered rows (namely, rows 0, 2, 4, and 6). In FIG. 8, the four samples “e” on each of the opposing sides of the edge—in columns 3 and 4 relative to the left side of the block (810)—are potentially affected by in-loop filtering when bit 4 indicates filtering is on.

Bit 5 controls in-loop deblock filtering across the vertical edge in the middle of the 8×8 block (810) for samples of odd-numbered rows (namely, rows 1, 3, 5 and 7). In FIG. 8, the four samples “f” on each of the opposing sides of the edge—in columns 3 and 4—are potentially affected by in-loop filtering when bit 5 indicates filtering is on.

Bit 6 controls in-loop deblock filtering across the horizontal edge in the middle of the 8×8 block (810) for samples of even-numbered rows. In FIG. 8, the eight samples “g” on each of the opposing sides of the edge—in rows 2 and 4 relative to the top side of the block (810)—are potentially affected by in-loop filtering when bit 6 indicates filtering is on.

Bit 7 controls in-loop deblock filtering across the horizontal edge in the middle of the 8×8 block (810) for samples of odd-numbered rows. In FIG. 8, the eight samples “h” on each of the opposing sides of the edge—in rows 3 and 5—are potentially affected by in-loop filtering when bit 7 indicates filtering is on.

With the protocol described with reference to FIG. 8, the same LOOPF_FLAG structure used for in-loop filtering control information for progressive mode and interlaced field mode can also be used for interlaced frame modes with semantic changes for the bits of the LOOPF_FLAG bytes. For interlaced frame mode, the LOOPF_FLAG structure assimilates filtering on/off decisions for edges in various permutations of blocks and subblocks for different transform sizes and field/frame macroblock mode decisions. Moreover, the LOOPF_FLAG structure and protocol apply for intra (“I”), predicted (“P”) and bi-predictive (“B”) interlaced video frames. As another side benefit, the LOOPF_FLAG protocol accounts for the influence of slice coding when slices are used. For example, rules about not filtering across slice boundaries can be applied by an encoder or decoder when parameterizing decisions for edges of blocks.

B. Signaling In-Loop Filtering Control Information for Interlaced Frames.

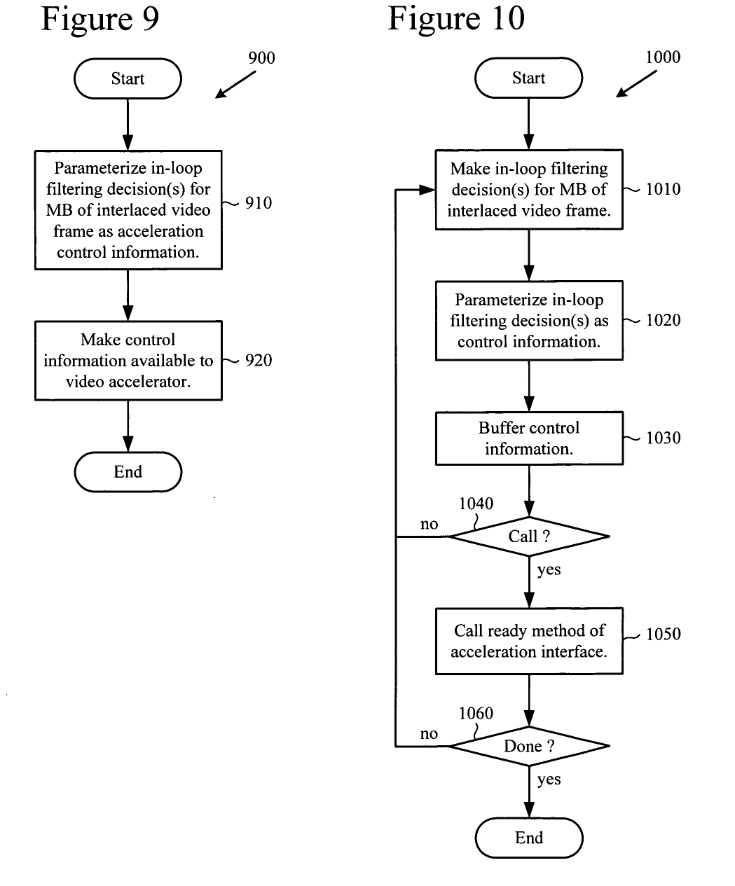

FIG. 9 shows a generalized technique (900) for signaling in-loop filtering control information for a macroblock of an interlaced video frame to a video accelerator across a video acceleration interface. A video decoder such as the decoder (700) shown in FIG. 7 performs the technique (900). Alternatively, another decoder, another tool such as an encoder, or software between an encoder/decoder and video acceleration interface performs the technique (900).

The decoder parameterizes (910) one or more in-loop filtering decisions for a macroblock of an interlaced video frame, resulting in in-loop filtering control information for video acceleration. For example, from one or more decisions about which edges of blocks of the macroblock should be filtered, the decoder produces on/off control information for the edges. The control information can follow the protocol explained with reference to FIG. 8 or follow some other protocol. Applying the protocol explained with reference to FIG. 8, for example, for an 8×8 block coded with an 8×8 transform and coded as part of a frame-mode macroblock, the filtering decisions about left and top edges, and the absence of filtering for internal edges, are parameterized as 8 bits of control information for the block.

The decoder then makes the control information available (920) to the video accelerator. For example, the decoder writes the control information to a buffer and, if appropriate, calls a method of the video acceleration interface to alert the video accelerator that control information is ready for processing. The video acceleration interface can follow DXVA guidelines or guidelines for another acceleration interface with buffers. Alternatively, the decoder uses a messaging mechanism or some other communications mechanism to make the control information available to the video accelerator.

FIG. 10 shows timing details of a technique (1000) for signaling in-loop filtering control information for a macroblock of an interlaced video frame. A decoder such as the video decoder (700) shown in FIG. 7 performs the technique (1000). Alternatively, another decoder or another tool such as an encoder performs the technique (1000).

The decoder makes (1010) one or more in-loop filtering decisions for a macroblock of an interlaced video frame. For example, the decoder applies the filtering decision criteria described in U.S. Patent Application Publication No. US-2005-0084012-A1, entitled “IN-LOOP DEBLOCKING FOR INTERLACED VIDEO.” Alternatively, the decoder makes the filtering decision(s) using other and/or additional criteria.

The decoder parameterizes (1020) the one or more in-loop filtering decisions as in-loop filtering control information for video acceleration. For example, from the one or more decisions, the decoder produces on/off control information indicating which edges of blocks of the macroblock should be filtered, following the protocol explained with reference to FIG. 8 or some other protocol.

The decoder buffers (1030) the control information. For example, the decoder writes the control information to a buffer that the decoder has reserved. The buffer may include other in-loop filtering control information and/or control information for other operations offloaded to the video accelerator. In some implementations, the decoder writes control information for a macroblock (e.g., macroblock parameter information indicating intra/inter status, frame/field status, macroblock type, etc., motion vector information such as number of motion vectors, information indicating which residuals have associated coefficient information in the bit stream) to the buffer, then writes the in-loop filtering control information to the buffer, then writes any residual or other transform coefficient data to a residual data buffer. Alternatively, the decoder uses more buffers (e.g., separate buffer for motion vector information) or fewer buffers for the control information.

The decoder then decides (1040) whether it should call a method of the video acceleration interface. If so, the decoder calls (1050) the method of the acceleration interface. Otherwise, the decoder continues with the next macroblock. In some implementations, for example, the decoder calls the method only after all of the control information and other information for a picture has been buffered. The decoder buffers picture parameters and buffers macroblock control information for the respective macroblocks, then calls the method when the information for the last macroblock (and its blocks) has been buffered. Alternatively, the decoder calls the method of the acceleration interface at some other interval, for example, on a slice-by-slice basis.

The decoder determines (1060) whether it is done and, if so, finishes. Otherwise, the decoder continues with the next macroblock. For example, the decoder determines whether there is another picture in a sequence to process, another slice in a picture to process, and so on.

FIGS. 9 and 10 show control information for a macroblock of an interlaced video frame. Alternatively, in-loop filtering control information is parameterized, signaled and/or received on a block-by-block basis or some other basis. Moreover, for the sake of simplicity, FIGS. 9 and 10 do not detail how the techniques (900, 1000) interact with other aspects of decoding/encoding or with signaling of other video acceleration control information.

C. Transferring In-Loop Filtering Control Information for Interlaced Frames.

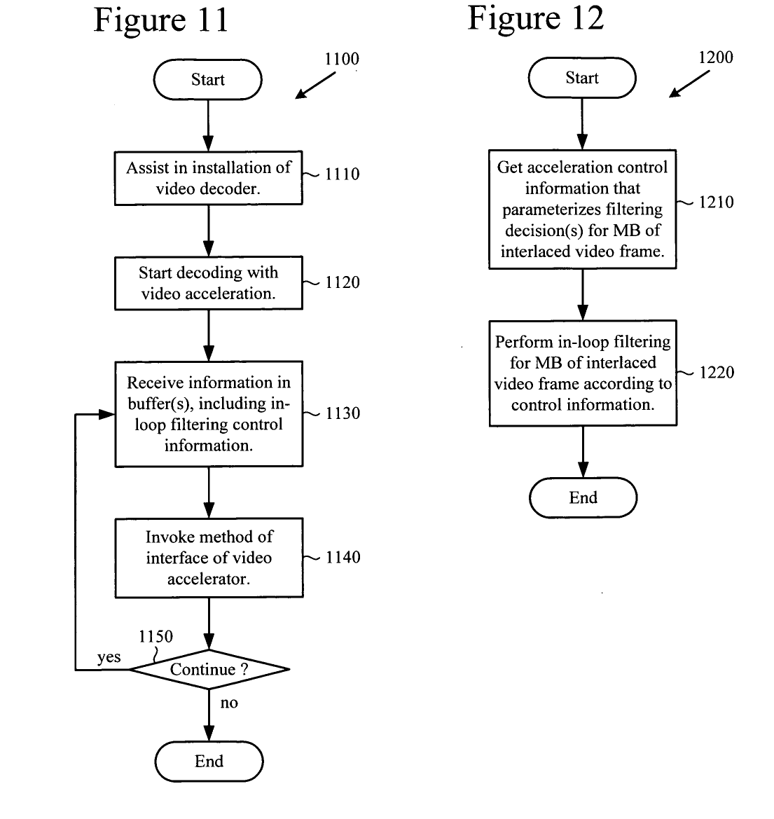

FIG. 11 shows a generalized technique (1100) for transferring in-loop filtering control information for interlaced video frames. An operating system or other software implementing an acceleration interface performs the technique (1100). The acceleration interface can be a DXVA interface or other type of acceleration interface.

At some point prior to decoding, the operating system assists (1110) in the installation of a video decoder. For example, the operating system incorporates information for the video decoder in a system registry, exposes access to the video decoder through a menu and/or icons on a user interface, registers the decoder as an available decoder on the system, associates content types with the decoder, and/or helps the decoder negotiate capabilities with a video accelerator.

After decoding starts (1120), the operating system receives (1130) control information and other information in one or more buffers, including in-loop filtering control information, and invokes (1140) a method of an interface of a video accelerator. For example, a decoder writes the control information for a picture in buffer(s) as described above with reference to FIG. 9, then calls a method of the acceleration interface, which causes the operating system to invoke (1140) the method of an interface of the video accelerator. Alternatively, the operating system invokes (1140) the method of the video accelerator interface more frequently (e.g., every slice) or less frequently.

The operating system determines (1150) whether it is done and, if so, finishes. Otherwise, the operating system waits, receiving (1130) information in the buffer (or a different buffer) and invoking (1140) the method of the video accelerator at appropriate times.

For the sake of simplicity, FIG. 11 does not detail various features of an acceleration interface, such as the reservation and release of buffers, and the various methods by which a decoder notifies the operating system that information is available for processing by the video accelerator. Such details are available in acceleration interface specifications such as those mentioned above. Moreover, although FIG. 11 shows a decoder interacting with software implementing a video acceleration interface, alternatively an encoder or other software tool interacts with the software implementing the video acceleration interface to transfer in-loop filtering control information for interlaced video frames.

D. Processing In-Loop Filtering Control Information for Interlaced Frames.

FIG. 12 shows a generalized technique (1200) for receiving and processing in-loop filtering control information for interlaced video frames in video acceleration. A video accelerator acting through a device driver, other software implementing a device driver interface, or other software for a video accelerator performs the technique (1200).

The video accelerator gets (1210) in-loop filtering control information that parameterizes one or more in-loop filtering decisions for a macroblock of an interlaced video frame. For example, the video accelerator reads the control information from a buffer when the video accelerator is alerted that control information is ready for processing. The video accelerator can receive the notification as a call to a method exposed through a DDI, according to a video acceleration interface that follows DXVA guidelines or guidelines for another acceleration interface with buffers. Alternatively, the video accelerator uses a messaging mechanism or some other communications mechanism to get the control information. The control information can follow the protocol explained with reference to FIG. 8 or follow some other protocol.

The video accelerator next performs (1220) in-loop filtering for the macroblock according to the control information. For example, for edges of the macroblock that are to be filtered, the video accelerator performs the filtering as described in U.S. Patent Application Publication No. US-2005-0084012-A1, entitled “IN-LOOP DEBLOCKING FOR INTERLACED VIDEO.” Alternatively, the video accelerator performs the filtering using other filtering rules.

FIG. 12 shows control information for a macroblock of an interlaced video frame. Alternatively, in-loop filtering control information is parameterized, signaled and/or received on a block-by-block basis or some other basis. Moreover, for the sake of simplicity, FIG. 12 does not show how the technique (1200) interacts with other aspects of decoding/encoding or with processing of other video acceleration control information.

Having described and illustrated the principles of our invention with reference to various embodiments, it will be recognized that the various embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of embodiments shown in software may be implemented in hardware and vice versa.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method comprising:
for a macroblock of an interlaced video frame, parameterizing plural in-loop filtering decisions as in-loop filtering control information for video acceleration, wherein the control information indicates filtering control decisions for plural external edges and plural internal edges of each of plural luma blocks and plural chroma blocks of the macroblock; and
making the control information available to a video accelerator.

2. The method of claim 1 further comprising, in a decoder:
receiving at least part of a bit stream; and
making the plural in-loop filtering decisions based at least in part upon plural parameters in the bit stream.

3. The method of claim 1 wherein the control information for the macroblock includes six bytes for six corresponding blocks of the macroblock, the six corresponding blocks including the plural luma blocks and the plural chroma blocks of the macroblock.

4. The method of claim 3 wherein each of the six bytes consists of two bits for left external edges of samples in alternate rows, two bits for top external edges of samples in adjacent columns, two bits for internal vertical edges of samples in alternate rows, and two bits for internal horizontal edges of samples in adjacent columns.

5. The method of claim 1 wherein each of the plural luma blocks and the plural chroma blocks is an 8×8 block, and wherein the plural external edges and the plural internal edges include four-sample vertical edges of samples in alternate rows and eight-sample horizontal edges of samples in adjacent columns of alternate rows.

6. The method of claim 1 wherein the plural in-loop filtering decisions are based at least in part upon plural parameters, the plural parameters including at least one macroblock parameter for the macroblock and plural block parameters for the plural luma blocks.

7. The method of claim 1 wherein the control information follows the same syntax but a different semantic as control information for a macroblock of a progressive frame or interlaced field.

8. The method of claim 1 wherein the making the control information available includes putting the control information in a buffer.

9. The method of claim 1 wherein the video accelerator comprises a device driver for a graphics processing unit.

10. A method comprising:
retrieving in-loop filtering control information for video acceleration, wherein the control information indicates in-loop filtering control decisions for plural external edges and plural internal edges of each of plural luma blocks and plural chroma blocks of a macroblock of an interlaced video frame; and
with a video accelerator, performing in-loop filtering for the macroblock based at least in part on the control information.

11. The method of claim 10 wherein the control information for the macroblock includes six bytes for six corresponding blocks of the macroblock, the six corresponding blocks including the plural luma blocks and the plural chroma blocks of the macroblock.

12. The method of claim 11 wherein each of the six bytes consists of two bits for left external edges of samples in alternate rows, two bits for top external edges of samples in adjacent columns, two bits for internal vertical edges of samples in alternate rows, and two bits for internal horizontal edges of samples in adjacent columns.

13. The method of claim 10 wherein each of the plural luma blocks and the plural chroma blocks is an 8×8 block, and wherein the plural external edges and the plural internal edges include four-sample vertical edges of samples in alternate rows and eight-sample horizontal edges of samples in adjacent columns of alternate rows.

14. The method of claim 10 wherein the control information follows the same syntax but a different semantic as control information for a macroblock of a progressive frame or interlaced field.

15. The method of claim 10 wherein the retrieving the control information includes reading the control information from a buffer.

16. The method of claim 10 wherein the video accelerator comprises a device driver for a graphics processing unit.

17. A computer-readable medium storing computer-executable instructions for causing a computer system programmed thereby to perform a method comprising:
receiving in-loop filtering control information for video acceleration in a buffer, wherein the control information indicates in-loop filtering control decisions for plural external edges and plural internal edges of each of plural luma blocks and plural chroma blocks of a macroblock of an interlaced video frame; and
invoking a method of an interface of a video accelerator, thereby indicating availability of the control information in the buffer to the video accelerator.

18. The computer-readable medium of claim 17 wherein the method further comprises:
before the receiving, assisting in installation of a video decoder, wherein the control information is received from the video decoder during execution of the video decoder.

19. The computer-readable medium of claim 17 wherein the control information for the macroblock includes six bytes for six corresponding blocks of the macroblock, the six corresponding blocks including the plural luma blocks and the plural chroma blocks of the macroblock, wherein each of the six bytes consists of two bits for left external edges of samples in alternate rows, two bits for top external edges of samples in adjacent columns, two bits for internal vertical edges of samples in alternate rows, and two bits for internal horizontal edges of samples in adjacent columns.

20. The method of claim 17 wherein each of the plural luma blocks and the plural chroma blocks is an 8×8 block, and wherein the plural external edges and the plural internal edges include four-sample vertical edges of samples in alternate rows and eight-sample horizontal edges of samples in adjacent columns of alternate rows.
